(19) United States
(12) Patent Application Publication
(10) Pub. No.: US 2026/0127417 A1
(43) Pub. Date: May 7, 2026

(54) INFERENCING TECHNIQUE SELECTION FOR GENERATIVE LANGUAGE MODELS

(71) Applicant: Microsoft Technology Licensing, LLC, Redmond, WA (US)

(72) Inventors: Eric Joel HORVITZ, Portola Valley, CA (US); Harsha Prasad NORI, Seattle, WA (US); Naoto USUYAMA, Sammamish, WA (US); Nicholas Bryan KING, Puyallup, WA (US)

(73) Assignee: Microsoft Technology Licensing, LLC, Redmond, WA (US)

(21) Appl. No.: 19/096,518

(22) Filed: Mar. 31, 2025

Related U.S. Application Data
(60) Provisional application No. 63/717,215, filed on Nov. 6, 2024.

(51) Int. Cl. G06N 3/0475; G06N 3/092

(52) U.S. Cl. CPC G06N 3/0475; G06N 3/092

(57) ABSTRACT

A computing system including one or more processing devices configured to receive an inferencing input and an inferencing performance target associated with the inferencing input. The one or more processing devices select a generative language model based at least on the inferencing performance target. The one or more processing devices select one or more inferencing techniques based at least on the inferencing performance target and generative language model metadata indicating whether the generative language model is a reasoning model. The one or more inferencing techniques are selected using an inferencing technique mapping that specifies a respective subset of the inferencing techniques for each of the generative language models and for each of the predetermined inferencing performance targets. The one or more processing devices compute an inferencing output at the generative language model using the one or more selected inferencing techniques, and output the inferencing output.

### CROSS REFERENCE TO RELATED APPLICATIONS

This application claims priority to U.S. Provisional Patent Application Ser. No. 63/717,215, filed Nov. 6, 2024, the entirety of which is hereby incorporated herein by reference for all purposes.

### BACKGROUND

Prompt engineering as a research area and craft has evolved in step with the fast-paced rise of generative language models such as large language models (LLMs), small language models (SLMs), and large multimodal models (LMMs). Prompts shape and focus the capabilities of generative language models trained to follow instructions. In some examples, rather than guiding the behavior of the generative language model with a single prompt, the generative language model may be included in a structured, multi-step prompt pipeline. These pipelines can focus and amplify the long-horizon planning capabilities of generative language models.

### SUMMARY

According to one aspect of the present disclosure, a computing system is provided, including one or more processing devices configured to receive an inferencing input. The one or more processing devices are further configured to receive an inferencing performance target associated with the inferencing input. The inferencing performance target is selected from among a plurality of predetermined inferencing performance targets. The one or more processing devices are further configured to select a generative language model from among a plurality of generative language models based at least in part on the inferencing performance target. The one or more processing devices are further configured to select one or more inferencing techniques from among a plurality of inferencing techniques based at least in part on the inferencing performance target and generative language model metadata indicating whether the generative language model is a reasoning model. The one or more inferencing techniques are selected using an inferencing technique mapping that specifies a respective subset of the plurality of inferencing techniques for each of the generative language models and for each of the predetermined inferencing performance targets. The one or more processing devices are further configured to compute an inferencing output at the generative language model using the one or more selected inferencing techniques. The one or more processing devices are further configured to output the inferencing output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to process an inferencing input at a generative language model using one or more inferencing techniques, according to one example embodiment.

FIG. 2 schematically shows inferencing technique selection logic that includes an inferencing technique mapping, according to the example of FIG. 1.

FIG. 3 schematically shows the computing system when the one or more processing devices are further configured to recompute the inferencing output with one or more additional inferencing techniques, according to the example of FIG. 1.

FIGS. 4A-4C show the results of experiments that were performed to test the effectiveness of different inferencing techniques on a reasoning model and another model, according to the example of FIG. 1.

FIG. 5 schematically shows the computing system during training of a reasoning model, according to the example of FIG. 1.

FIG. 6A shows a flowchart of a method for use with a computing system that includes a plurality of generative language models, according to the example of FIG. 1.

FIG. 6B shows example steps of the method of FIG. 6A that may be performed when one or more inferencing techniques are selected.

FIG. 6C shows additional steps of the method of FIG. 6A that may be performed to train the reasoning model.

FIG. 7 shows a schematic view of an example computing environment in which the computing system of FIG. 1 may be instantiated.

### DETAILED DESCRIPTION

Inference-time strategies have been used to bridge the gap between 1) general-purpose generative language models and 2) domain-specific models that rely on a fixed set of expert-curated prompts and fine-tuning on specialized datasets. For example, a set of inferencing techniques referred to as Medprompt has been used to enhance model performance on medical challenge benchmarks. Medprompt utilizes dynamic chain-of-thought reasoning, curated few-shot examples, and choice-shuffle ensembling. Using Medprompt, the error rates of a generative language model on complex medical benchmarks such as MedQA can be reduced by nearly 50%, without adapting model weights to the medical domain.

Recent advancements in model training methodologies, exemplified by the o1-preview model, have also been used to harness the inherent capabilities of generative language models. In distinction to previous models, o1-preview incorporates chain-of-thought (CoT) reasoning as part of its training process, yielding a reasoning model that is trained to perform sophisticated step-by-step problem-solving during inference. The term “reasoning model,” as used herein, refers to a generative language model that has been specifically trained to follow a CoT response pattern even when CoT generation instructions are not included in the prompt. For example, as discussed in further detail below, a reasoning model may be trained on CoT traces using supervised fine-tuning and/or reinforcement learning.

When used with reasoning models, inferencing techniques such as CoT prompting, few-shot prompting, and ensembling have different effects on output generation quality and inferencing efficiency, compared to other generative language models. In order to elicit desired behaviors from a reasoning model and obtain those results in an efficient manner, a user may have to use a different set of inferencing techniques from those that achieve high performance when used with other types of generative language models. A user who switches between generative language model types may therefore have to learn new prompting and scaffolding strategies and may have difficulty eliciting some desired behaviors from the generative language model. In addition, a user may unintentionally waste computing resources on some tasks that could be performed at a generative language model in a less compute-intensive manner.

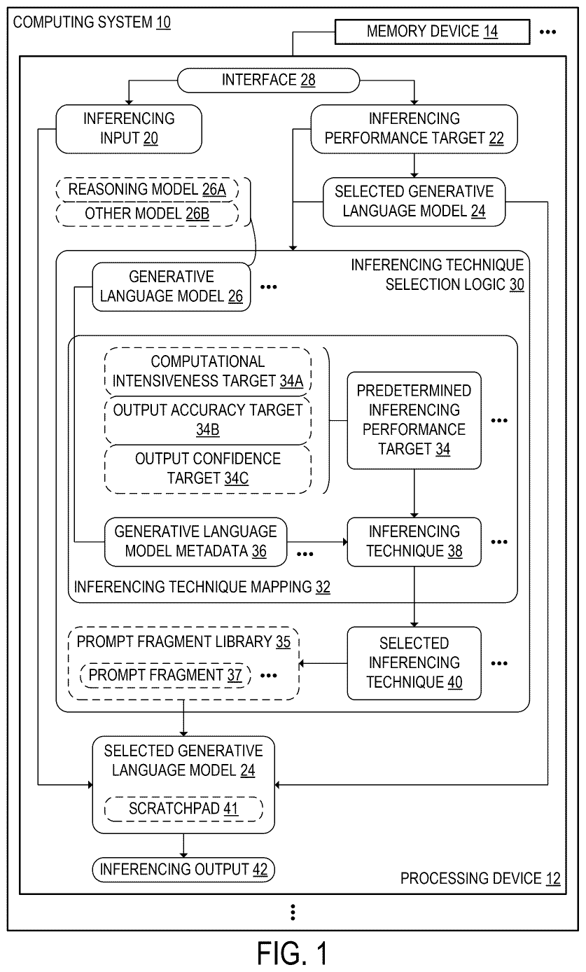

In order to address the above challenges, a computing system 10 is presented, as depicted schematically according to the example of FIG. 1. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices.

In some examples, the one or more processing devices 12 and the one or more memory devices 14 may be distributed among a plurality of different physical computing devices. For example, the physical computing devices included in the computing system 10 may have a server-client configuration. In other examples, the computing system 10 may be implemented at a single physical computing device.

The one or more processing devices 12 are configured to receive an inferencing input 20. The inferencing input 20 may be a text input. In examples in which an LMM is executed at the computing system 10, one or more other input modalities such as image input or audio input may additionally or alternatively be included in the inferencing input 20.

The inferencing input 20 may be received via an interface 28, which may be a user interface, an application-programming interface (API), or an ML system internal interface. In examples in which the interface 28 is a user interface, the interface 28 may be a graphical user interface (GUI) or an audio interface. In examples in which the interface 28 is an API, the one or more processing devices 12 may be configured to receive the inferencing input 20 from another application program. In examples in which the interface 28 is an ML system internal interface, the interface 28 may be executed to pass inputs and outputs between different ML models, and/or scaffolding code associated with those ML models, as a component of an ML system in which multiple ML models are included. Thus, in such examples, the one or more processing devices 12 may be configured to receive the inferencing input 20 as an output of an ML model included in the ML system, either as a raw output or following one or more post-processing operations.

The one or more processing devices 12 are further configured to receive an inferencing performance target 22 associated with the inferencing input 20. The inferencing performance target 22 is selected from among a plurality of predetermined inferencing performance targets 34. Each of the predetermined inferencing performance targets 34 may be expressed in terms of input resources and/or output properties of generative language model inferencing. For example, each of the predetermined inferencing performance targets 34 may be a computational intensiveness target 34A, an output accuracy target 34B, or an output confidence target 34C. The one or more processing devices 12 may be configured to receive the inferencing performance target 22 over the interface 28.

Predetermined computational intensiveness targets 34A may be expressed in terms of different computing resources and may be estimated ranges of the amounts of those resources. For example, a predetermined computational intensiveness target 34A may be expressed in terms of the total amount of computation (e.g., in FLOPs) performed when processing the inferencing input 20 to obtain an inferencing output 42. As another example, the predetermined computational intensiveness target 34A may be expressed in terms of an amount of memory used or an estimated inferencing duration. In some examples, the predetermined computational intensiveness target 34A may be based on two or more different computational resources, such as time and memory. For example, the one or more processing devices 12 may be configured to compute a predetermined computational intensiveness target 34A as a weighted score over a combination of different computational resources.

In examples in which the inferencing performance target 22 is an output accuracy target 34B, the inferencing performance target 22 may be expressed as an accuracy range (e.g., a range of percentage values) or an acceptable error rate for the inferencing output 42. In examples in which the inferencing performance target 22 is an output confidence target 34C, the output confidence target 34C may be expressed as a threshold confidence value at which the one or more processing devices 12 are configured to output the inferencing output 42. As discussed in further detail below, the one or more processing devices 12 may be configured to recompute the inferencing output 42 when the inferencing output 42 has an output confidence below the output confidence target 34C.

The one or more processing devices 12 are further configured to select a generative language model 24 from among a plurality of generative language models 26 based at least in part on the inferencing performance target 22. For example, the one or more processing devices 12 may be configured to select a generative language model 24 with a size that fits within a memory requirement specified by a computational intensiveness target 34A. As another example, a generative language model 24 with a long inferencing time may be selected in response to the user selecting a high output accuracy target 34B that trades off inferencing speed in favor of higher response accuracy. The one or more processing devices 12 may be configured to select the generative language model 24 based at least in part on generative language model metadata 36 that specifies the respective properties of the generative language models 26, as discussed in further detail below.

In some examples, rather than programmatically selecting a generative language model 24 based at least in part on the inferencing performance target 22, the one or more processing devices 12 may instead be configured to receive the selection of the generative language model 24 over the interface 28. In examples in which the interface 28 is a user interface, the user may directly select the generative language model 24 at the interface 28 from among the plurality of generative language models 26. As another example, the generative language model 24 may be selected by another ML model included in an ML system, and this selection may be transmitted over an ML system internal interface.

The one or more processing devices 12 are further configured to execute inferencing technique selection logic 30 to select one or more runtime model inferencing techniques 40 from among a plurality of inferencing techniques 38. Each of the inferencing techniques 38 is a prompting structure or model scaffolding process with which the one or more processing devices 12 are configured to guide the processing of the inferencing input 20 at the selected generative language model 24. An inferencing technique 38 may be implemented within a context window of the selected generative language model 24 as a prompting technique, outside the selected generative language model 24 as a model scaffolding technique, or in a manner that includes both prompting and scaffolding. Examples of specific inferencing techniques 38 are discussed below.

The one or more processing devices 12 are configured to select the one or more inferencing techniques 40 based at least in part on the inferencing performance target 22. Since some inferencing techniques 38 include performing additional inferencing at the selected generative language model 24, the one or more selected inferencing techniques 40 may affect whether the processing of the inferencing input 20 meets a computational intensiveness target 34A. The one or more selected inferencing techniques 40 also affect the accuracy and confidence of the inferencing output 42.

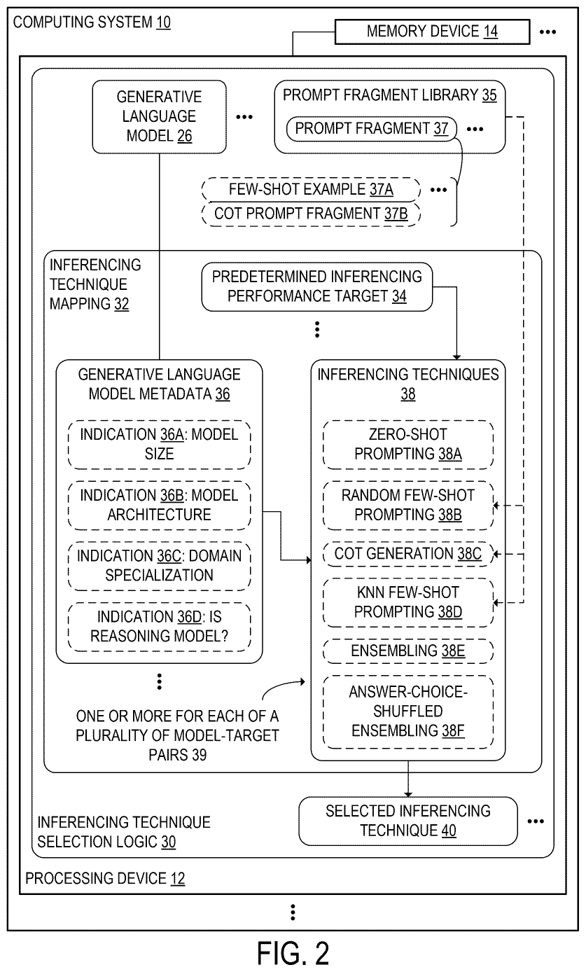

The one or more processing devices 12 are also configured to select the one or more inferencing techniques 40 based at least in part on respective generative language model metadata 36 associated with each of the generative language models 26. Examples of different types of generative language model metadata 36 that may be associated with a specific generative language model 26 are shown in FIG. 2. As depicted in FIG. 2, the generative language model metadata 36 may include an indication 36A of the size of the generative language model 26, which may be expressed in terms of parameter count or total storage size in memory. The generative language model metadata 36 may further include an indication 36B of a model architecture of the generative language model 26. In examples in which the generative language model 26 is a domain-specific model, such as a model that has been fine-tuned to specialize in a particular language modeling task or domain of knowledge, the generative language model metadata 36 may further include an indication 36C of the domain specialization of the generative language model 26.

As shown in the example of FIG. 1, the plurality of generative language models 26 include one or more reasoning models 26A and one or more other models 26B that have not been trained as reasoning models. For each of the generative language models 26, the corresponding generative language model metadata 36 further includes an indication 36D of whether the generative language model 26 is a reasoning model 26A. As discussed above, a reasoning model 26A is a generative language model that has been trained to perform CoT generation during inferencing even when its prompt does not include a CoT elicitation prompt fragment. The reasoning model 26A may additionally be configured to write one or more output tokens to a scratchpad 41 during inferencing, and to compute the inferencing output 42 based at least in part on the one or more output tokens included in the scratchpad 41.

A generative language model that is not a reasoning model would typically require a prompt fragment such as “Let's think step by step” or “Present your reasoning one step at a time,” and/or few-shot prompting with examples of CoT reasoning traces. Although CoT traces may occur in the training data that is used to pretrain the one or more other models 26B, those other models 26B have not been specifically fine-tuned or reinforcement-trained on CoT traces after pretraining.

In the example of FIG. 1, the one or more inferencing techniques 40 are selected using an inferencing technique mapping 32. The inferencing technique mapping 32 specifies a respective subset of the plurality of inferencing techniques 38 for each of the generative language models 26 and for each of the predetermined inferencing performance targets 34. Thus, as shown in FIG. 2, the inferencing technique mapping 32 maps each of a plurality of model-target pairs 39 to a respective set of one or more inferencing techniques 38. In some examples, the inferencing technique mapping 32 specifies which inferencing technique 38, or combination of inferencing techniques 38, is on a Pareto frontier of output accuracy versus computational intensiveness for the plurality of generative language models 26.

In some examples, the inferencing technique mapping 32 may be structured as a lookup table over different values of the inferencing performance target 22 and the selected generative language model 24. In other examples, rather than a precomputed lookup table, the inferencing technique mapping 32 may be a function that the one or more processing devices 12 are configured to evaluate with indicators of the inferencing performance target 22 and the selected generative language model 24 as inputs. For example, the inferencing technique mapping 32 may be an inferencing technique selection ML model.

Returning to FIG. 1, after the one or more inferencing techniques 40 have been selected, the one or more processing devices 12 are further configured to compute the inferencing output 42 at the selected generative language model 24 using the one or more selected inferencing techniques 40. In some examples, the one or more processing devices 12 are configured to load one or more additional prompt fragments 37 from a prompt fragment library 35 into a context window of the selected generative language model 24 in addition to the inferencing input 20 specified by the user. Additionally or alternatively, performing the one or more selected inferencing techniques 40 may include making one or more additional inferencing calls to the generative language model 24.

The one or more processing devices 12 are further configured to output the inferencing output 42 to an additional computing process. For example, the inferencing output 42 may be output to the interface 28 for presentation to the user or transmission to another component of an ML system. One or more post-processing operations may be performed on the inferencing output 42 in some examples.

FIG. 2 further shows examples of inferencing techniques 38 that the one or more processing devices 12 may select at the inferencing technique selection logic 30. The plurality of inferencing techniques 38 may include zero-shot prompting 38A. When zero-shot prompting 38A is performed, the one or more processing devices 12 are configured to input the inferencing input 20 into the generative language model 24 without also inserting additional examples into the context window.

In some examples, the one or more processing devices 12 may be configured to select zero-shot prompting 38A using the inferencing technique mapping 32 in response to determining that the generative language model metadata 36 indicates that the generative language model 24 is a reasoning model 26A. In some experiments, as discussed in further detail below, few-shot prompting has been found to decrease the accuracy of reasoning models. Thus, zero-shot prompting 38A may be selected instead when a reasoning model 26A is used to process the inferencing input 20.

The plurality of inferencing techniques 38 may further include random few-shot prompting 38B. In random few-shot prompting, one or more few-shot examples 37A of a generative language modeling task (e.g., summarization, translation, code generation, or checking for errors) are inserted into the context window of the generative language model 24 along with the inferencing input 20. The one or more few-shot examples 37A are selected at random from the prompt fragment library 35, which, in the example of FIG. 2, includes a plurality of prompt fragments 37 that provide a larger set of examples of the generative language modeling task. The one or more processing devices 12 may also insert a prompt fragment 37 that instructs the generative language model 24 to follow the pattern of the few-shot examples 37A.

In some examples, the user may specify, at the interface 28, the generative language modeling task for which the one or more processing devices 12 are configured to select the one or more few-shot examples 37A. The generative language modeling task may, in such examples, be included in the inferencing input 20. In other examples, the generative language modeling task may be determined programmatically, such as a language modeling task classifier ML model included in the inferencing technique selection logic 30.

The plurality of inferencing techniques 38 may further include CoT generation 38C. The one or more processing devices 12 may be configured to select CoT generation 38C in examples in which the generative language model 24 is not a reasoning model 26A. In such examples, the one or more processing devices 12 may be configured to insert a CoT prompt fragment 37B such as “Let's think step by step” into the context window of the generative language model 24. However, utilizing a CoT prompt fragment 37B when a reasoning model 26A is used typically lowers the quality of the inferencing output 42. Thus, by referring to the generative language model metadata 36 to determine whether the selected generative language model 24 is a reasoning model 26A, the one or more processing devices 12 are configured to avoid using duplicative CoT prompting instructions that may decrease output quality.

In some examples, the plurality of inferencing techniques 38 may include k-nearest-neighbors (kNN) few-shot prompting 38D. In kNN few-shot prompting, the one or more processing devices 12 are configured to insert k few-shot examples 37A from the prompt fragment library 35 into the context window of the generative language model 24, where k is a predefined number of examples. These few-shot examples 37A are selected according to their distances (e.g., in terms of L2 distance or cosine similarity) from the inferencing input 20 in an embedding space. Thus, relevant few-shot examples 37A may be inserted into the context window.

The plurality of inferencing techniques 38 may include ensembling 38E over a plurality of inferencing passes. When ensembling is performed, the one or more processing devices 12 are configured to process the inferencing input 20 at the generative language model 24 multiple times. The one or more processing devices 12 are further configured to aggregate the resulting outputs of the generative language model to compute the inferencing output 42. The one or more processing devices 12 may be configured to select ensembling 38E in some examples when the inferencing input 20 prompts the generative language model 24 for an answer to a multiple-choice question. The aggregation performed after the inferencing input 20 has been processed multiple times may, for example, be majority-vote aggregation. Alternatively, ensemble refinement may be used to aggregate the generative language model outputs. Ensemble refinement employs multi-stage aggregation by generating multiple reasoning paths through stochastic sampling. Rather than relying solely on majority voting, the generative language model 24 iteratively re-conditions on intermediate outputs, refining its generated output at each stage to achieve higher precision.

In some examples in which ensembling is selected as an inferencing technique, the ensembling may be answer-choice-shuffled ensembling 38F. In answer-choice-shuffled ensembling, the one or more processing devices 12 are configured to randomly reorder a sequence of multiple-choice answers included in the prompt. The different inferencing passes performed during answer-choice-shuffled ensembling 38F have a plurality of different orders in which the multiple-choice answers are arranged. Some generative language models 26 exhibit biases toward specific positions in lists of multiple-choice answers (e.g., toward the first answer listed). By using answer-choice-shuffled ensembling, the one or more processing devices 12 may be configured to correct for these positional biases.

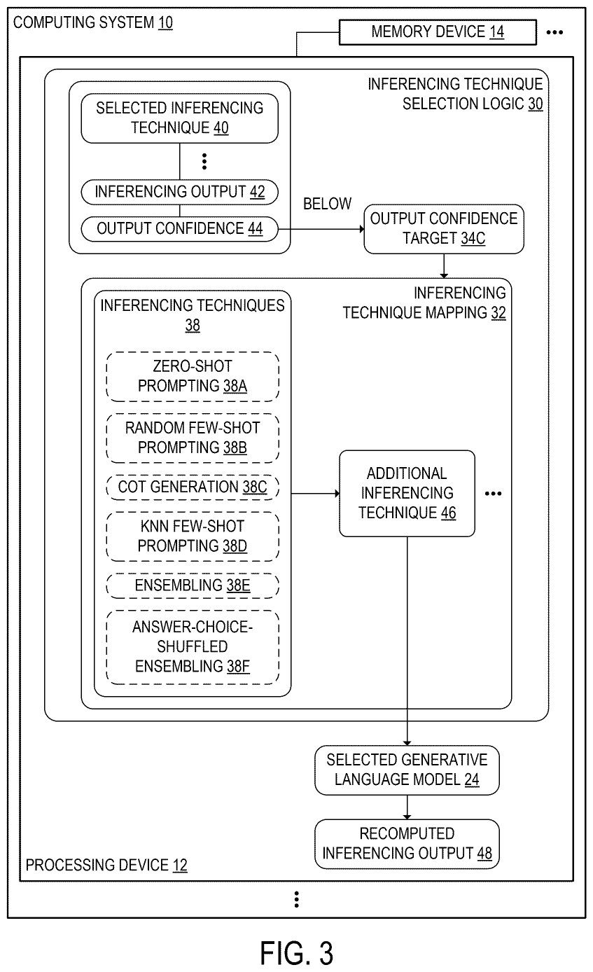

FIG. 3 schematically shows the computing system 10 in an example in which the inferencing performance target 22 includes an output confidence target 34C. When the one or more processing devices 12 compute the inferencing output 42, according to the example of FIG. 3, the one or more processing devices 12 are further configured to compute an output confidence 44 associated with the inferencing output 42. For example, the inferencing output 42 may be a logit value of a token selected as the inferencing output 42. In other examples, a prompt fragment 37 instructing the selected generative language model 24 to compute a confidence of its inferencing output 42 may be included in the prompt.

The one or more processing devices 12 are further configured to compare the output confidence 44 to the output confidence target 34C. In response to determining that the output confidence 44 is below the output confidence target 34C, the one or more processing devices 12 may be further configured to select one or more additional inferencing techniques 46 from among the plurality of inferencing techniques 38 using the inferencing technique mapping 32. The one or more processing devices 12 are further configured to compute a recomputed inferencing output 48 at the selected generative language model 24 using the one or more additional inferencing techniques 46. Thus, in the example of FIG. 3, the one or more processing devices 12 are configured to make an additional attempt to reach the output confidence target 34C by recomputing the inferencing output 42 using the one or more additional inferencing techniques 46. In examples in which the recomputed inferencing output 48 is still below the output confidence target 34C, the one or more processing devices 12 may be further configured to repeat the inferencing technique addition and inferencing output recomputation shown in FIG. 3.

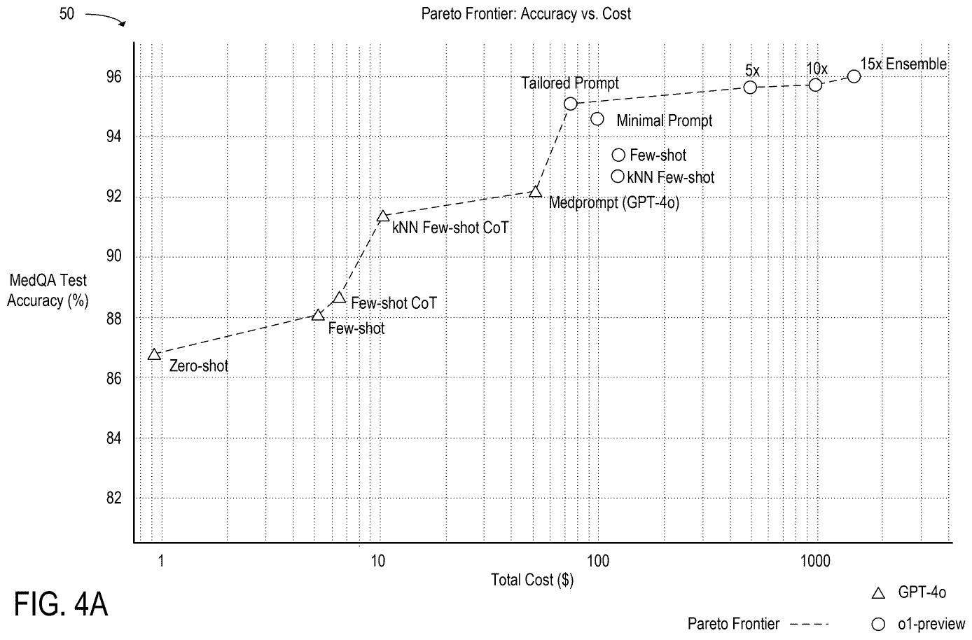

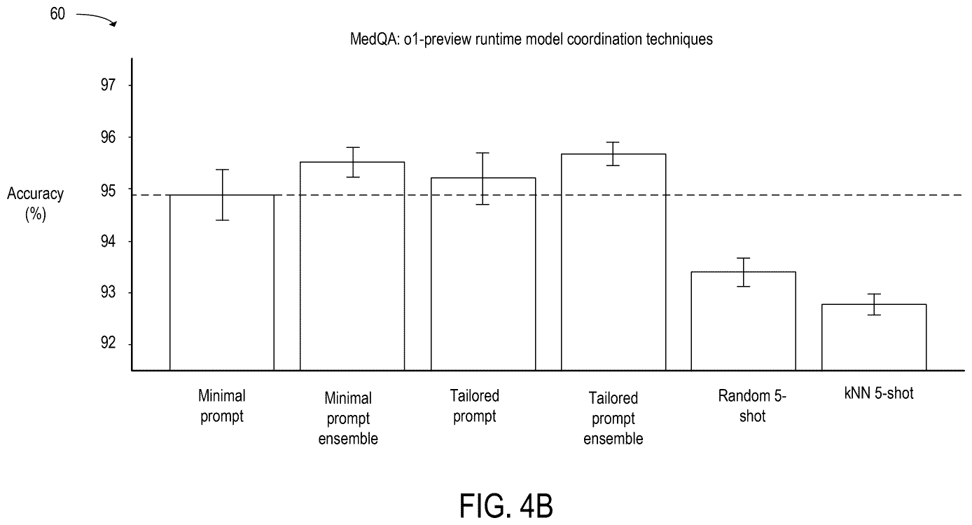

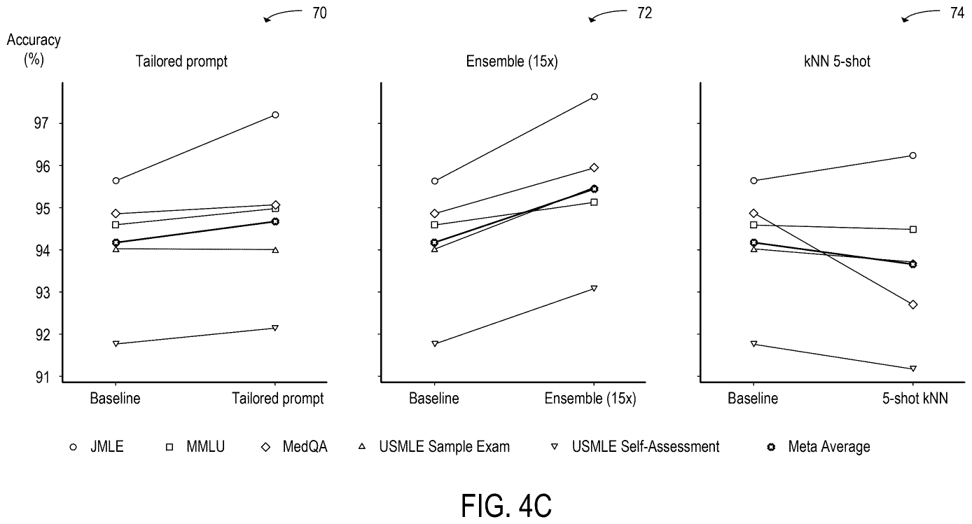

FIGS. 4A-4C show the results of experiments that were performed to test the effectiveness of different runtime model inferencing techniques 38 on a reasoning model 26A and another model 26B. In these experiments, o1-preview was used as the reasoning model 26A and GPT-40 was used as the other model 26B. In these experiments, the generative language models were tested on medical question-answering benchmarks.

FIG. 4A shows a plot 50 of accuracy versus total cost on the MedQA benchmark, which includes 1273 total questions. The plot 50 shows accuracy and cost values for GPT-40 and o1-preview when different inferencing techniques are applied. In addition, the plot 50 shown in FIG. 4A compares a minimal prompt (a prompt that includes a brief description of the task) to a tailored prompt (a prompt that includes a detailed description of the task). The “Medprompt” point on the plot 50 refers to a combination of CoT generation 38C, kNN few-shot prompting 38D, and answer-choice-shuffled ensembling 38F.

The plot 50 shown in FIG. 4A further depicts the Pareto frontier of accuracy versus cost for GPT-40 and o1-preview. As shown from the Pareto frontier, the accuracy of GPT-40 increases as random few-shot prompting 38B, CoT generation 38C, kNN few-shot prompting 38D, and answer-choice-shuffled ensembling 38F are added as inferencing techniques 38. However, inferencing techniques other than ensembling 38E and use of a tailored prompt instead decrease the accuracy of o1-preview while also having higher costs. The tailored prompt decreases the inferencing cost of o1-preview compared to the minimal prompt, since the tailored prompt allows o1-preview to perform fewer reasoning steps at the scratchpad 41 before reaching its answers.

FIG. 4B shows a plot 60 that compares accuracy of o1-preview on the MedQA benchmark for different inferencing techniques 38. As shown in FIG. 4B, ensembling over multiple inferencing passes and using the tailored prompt both increase accuracy, whereas random 5-shot prompting and kNN 5-shot prompting both decrease accuracy.

FIG. 4C shows plots 70, 72, and 74 of the performance of o1-preview when used with a tailored prompt, 15× ensembling, and kNN 5-shot prompting, respectively, compared to a zero-shot minimal-prompt baseline. The accuracy of o1-preview with these inferencing techniques 38 is shown for benchmarks including the 2024 Japanese Medical Licensing Exam (JMLE), the medical portion of MMLU, a sample US Medical Licensing Exam (USMLE Sample Exam), and a US Medical Licensing Exam self-assessment (USMLE Self-Assessment). In addition, the plots 70, 72, and 74 show the average accuracy of o1-preview for these benchmarks. The tailored prompt and 15× ensembling both increase the average accuracy of o1-preview, whereas 5-shot kNN prompting reduces the average accuracy.

An example of a minimal prompt used in the experiments is provided below. When few-shot prompting is used, the {examples} field is filled with the few-shot examples. The {examples} field is left blank when zero-shot prompting is used. The {question} field and the {answer choices} field are respectively filled with the question and answer choices on which the generative language model is tested.

The following are multiple choice questions (with answers) about medical knowledge.

{examples}
**Question**: {question}
{answer choices}
**Answer**: (

An example of a tailored prompt used in the experiments is provided below.

You are tasked with solving complex medical questions that assess both the knowledge and clinical reasoning required for a medical licensing exam. These questions cover critical topics such as anatomy, physiology, pathology, pharmacology, and patient management. Read the following question carefully and select the most accurate answer from the provided options.

**Question**:
{question}
**Options**:
{answer choices}
**Instructions**:
- Think deeply and thoroughly, then choose the best possible answer from
the given options (only one choice).
- Your final response must contain only the letter corresponding to the
correct answer (e.g., ”A”). Do not include explanations or additional text
in your output.
**Answer**:

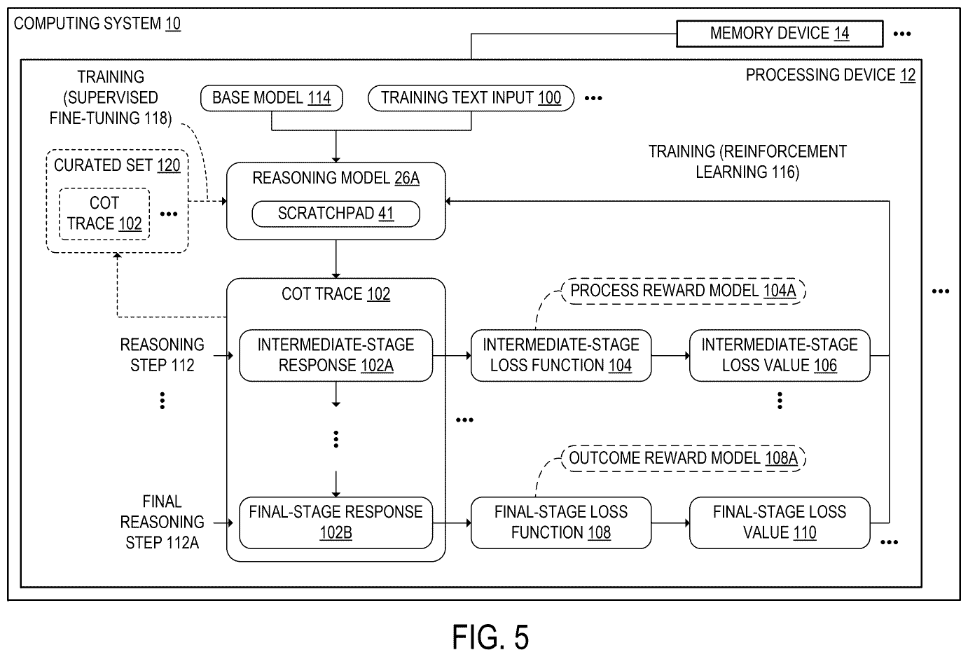

FIG. 5 schematically shows the computing system 10 during training of a reasoning model 26A, according to one example. This training may be performed starting from a base model 114. In the example of FIG. 5, the reasoning model 26A is trained using reinforcement learning 116 and/or supervised fine-tuning 118 on CoT traces 102. The training process shown in FIG. 5 includes computing the CoT traces 102 at the reasoning model 26A. Each CoT trace 102 is computed from a respective training text input 100. The CoT traces 102 each include one or more intermediate-stage responses 102A computed at the scratchpad 41 of the reasoning model 26A at corresponding reasoning steps 112. In addition, each of the CoT traces 102 includes a final-stage response 102B computed at a final reasoning step 112A.

For each of the CoT traces 102, based at least in part on the one or more intermediate-stage responses 102A, the one or more processing devices 12 may be further configured to compute one or more respective intermediate-stage loss values 106 using an intermediate-stage loss function 104. The one or more processing devices 12 are further configured to compute one or more respective final-stage loss values 110 based at least in part on the final-stage response 102B using a final-stage loss function 108.

In examples in which reinforcement learning 116 is used, the one or more processing devices 12 are further configured to train the reasoning model 26A using reinforcement learning 116 based at least in part on the one or more intermediate-stage loss values 106 and the final-stage loss value 110.

In examples in which supervised fine-tuning 118 is used, the one or more processing devices 12 are further configured to fine-tune the reasoning model 26A on a curated set 120 of CoT traces 102. For example, the curated set 120 of CoT traces 102 may be selected by a user. In some examples, the curated set 120 of CoT traces 102 may include one or more CoT traces 102 generated at a different generative language model 26.

Variants of the setup shown in FIG. 5 may alternatively be used to train the reasoning model 26A. For example, the one or more processing devices 12 may be configured to utilize one or more ML models to compute the intermediate-stage loss values 106 and the final-stage loss values 110, additionally or alternatively to the intermediate-stage loss function 104 and the final-stage loss function 108. In such examples, the one or more processing devices 12 may be configured to input the one or more intermediate-stage responses 102A (either individually or together) of a CoT trace 102 into a process reward model 104A configured to estimate the accuracy of the reasoning included in the one or more intermediate-stage responses 102A. The one or more processing devices 12 may be further configured to post-process the output of the process reward model 104A to compute the intermediate-stage loss value 106. Similarly, the one or more processing devices 12 may be configured to input the final-stage response into an outcome reward model 108A and post-process the output of the outcome reward model 108A to compute the final-stage loss value 110. The process reward model 104A and/or the outcome reward model 108A may be a generative language model. In some examples, the reasoning model 26A may be used as its own process reward model 104A and/or outcome reward model 108A during at least a portion of its training.

As another variant of the training pipeline shown in FIG. 5, the one or more processing devices 12 may be configured to utilize a final-stage loss function 108 without an intermediate-stage loss function 104. In such examples, the reasoning model 26A may be trained based on the accuracy of the final-stage response 102B without training on the one or more intermediate-stage responses 102A.

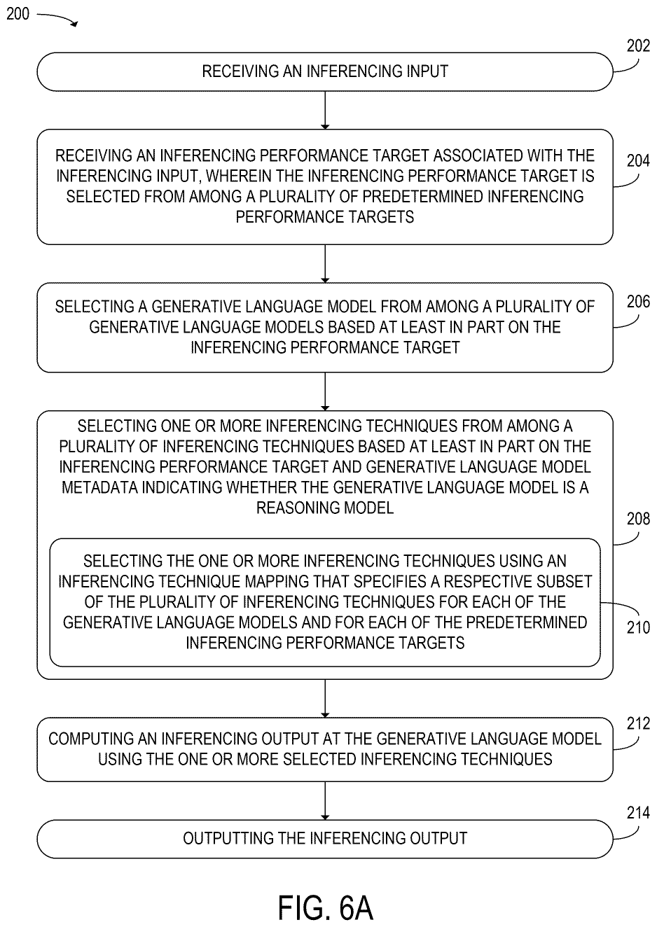

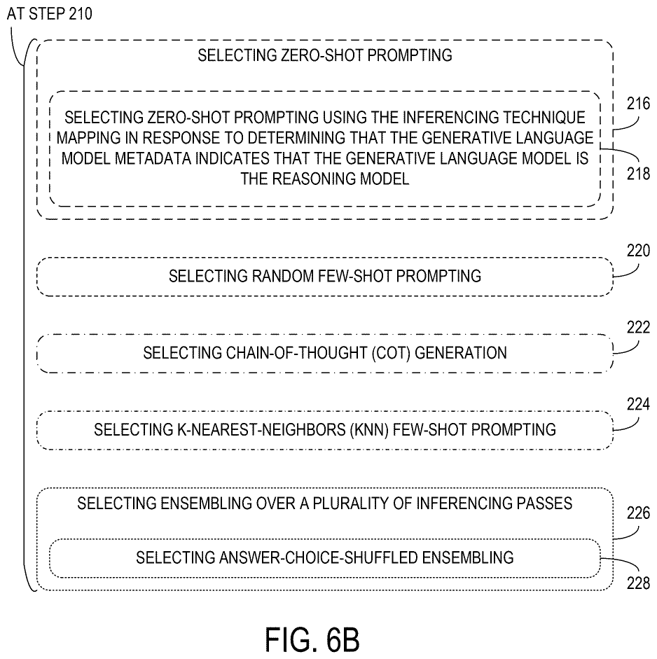

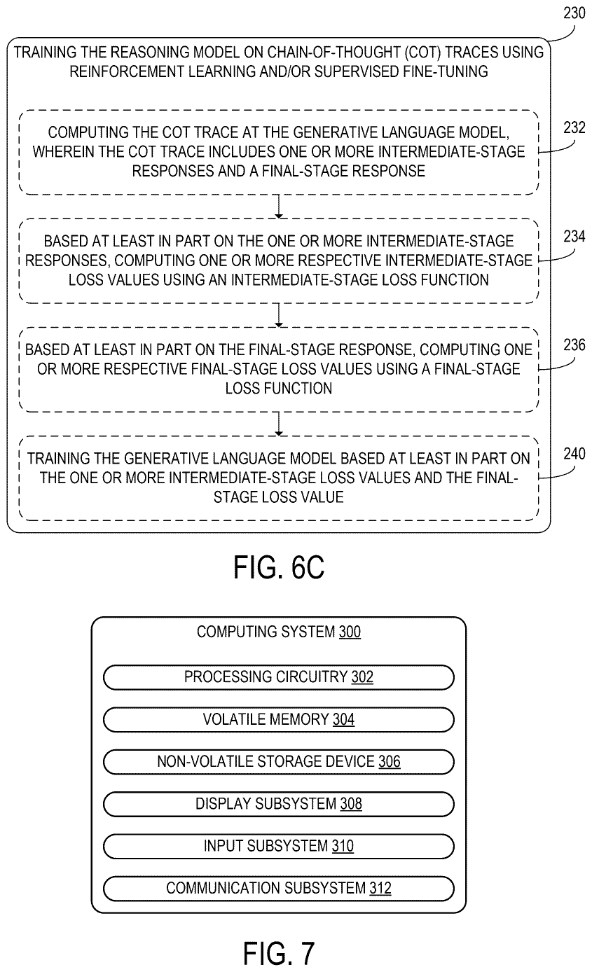

FIG. 6A shows a flowchart of a method 200 for use with a computing system that includes a plurality of generative language models. At step 202, the method 200 includes receiving an inferencing input. The inferencing input may be a text input. In examples in which the plurality of generative language models include one or more LMMs such as GPT-40, the inferencing input may additionally or alternatively include some other input modality. The inferencing input may be received as a user input via a user interface, such as a GUI or an audio interface. Alternatively, the inferencing input may be received via an API or an ML system internal interface.

At step 204, the method 200 further includes receiving an inferencing performance target associated with the inferencing input. The inferencing performance target is selected from among a plurality of predetermined inferencing performance targets. Each of the predetermined inferencing performance targets may be a computational intensiveness target, an output accuracy target, or an output confidence target. For example, a predetermined computational intensiveness target may be a range of values of a computational resource such as memory usage, processing time, or number of FLOPs. The predetermined computational intensiveness target may alternatively be a range of weighted scores computed from the values of different computational resources.

At step 206, the method 200 further includes selecting a generative language model from among a plurality of generative language models based at least in part on the inferencing performance target. The generative language model may be selected based at least in part on corresponding generative language model metadata associated with the generative language models.

At step 208, the method 200 further includes selecting one or more inferencing techniques from among a plurality of inferencing techniques. Since different inferencing techniques utilize different amounts of computing resources, the one or more inferencing techniques are selected based at least in part on the inferencing performance target. In addition, the one or more inferencing techniques are selected based at least in part on generative language model metadata indicating whether the generative language model is a reasoning model. A reasoning model is a generative language model that is trained to compute its outputs in a CoT structure, even when its prompt does not include a CoT prompt fragment that instructs the generative language model to perform CoT generation. The effects of some inferencing techniques differ when applied to reasoning models, compared to other types of generative language models. Thus, the selection of the one or more inferencing techniques utilizes generative language model metadata indicating whether the selected generative language model is a reasoning model.

At step 210, step 208 includes selecting the one or more inferencing techniques using an inferencing technique mapping. The inferencing technique mapping specifies a respective subset of the plurality of inferencing techniques for each of the generative language models and for each of the predetermined inferencing performance targets. The inferencing technique mapping may specify one or more inferencing techniques for each of a plurality of model-target pairs. For example, the inferencing technique mapping may be a lookup table that maps the model-target pairs to inferencing techniques. Alternatively, the inferencing technique mapping may be some other type of function such as an inferencing technique selection ML model. In some examples, the inferencing technique mapping specifies a Pareto frontier of model output accuracy as a function of a metric of computational intensiveness (e.g., a specific computational resource or a weighted combination thereof). In such examples, the one or more selected inferencing techniques may be a set of inferencing techniques located on the Pareto frontier.

At step 212, the method 200 may further include computing an inferencing output at the generative language model using the one or more selected inferencing techniques. In some examples, the inferencing input and one or more prompt fragments from a prompt fragment library may be loaded into the context window of the selected generative language model, which then processes the resulting prompt at step 212 to compute the inferencing output. At step 214, the method 200 further includes outputting the inferencing output. The inferencing output may be output to the user interface in some examples. Alternatively, the inferencing output may be output to some other computing process such as another ML model included in an ML system.

FIG. 6B shows example steps of the method 200 that may be performed at step 210 when the one or more inferencing techniques are selected. At step 216, step 210 may further include selecting zero-shot prompting. For example, at step 218, step 216 may include selecting zero-shot prompting using the inferencing technique mapping in response to determining that the generative language model metadata indicates that the generative language model is the reasoning model. When zero-shot prompting is performed, examples of a requested language processing task are not inserted into the prompt.

At step 220, step 210 may further include selecting random few-shot prompting. When few-shot prompting is performed, the prompt further includes one or more randomly selected few-shot examples of the requested language processing task. The one or more few-shot examples may be selected from a prompt library that includes a plurality of predefined prompt fragments.

At step 222, step 210 may further include selecting chain-of-thought (CoT) generation. When CoT generation is performed, a CoT prompt fragment such as “Think step-by-step” is included in the prompt.

At step 224, step 210 may further include selecting kNN few-shot prompting. When kNN few-shot prompting is performed, one or more few-shot examples are selected from the prompt library. The selected examples are the k few-shot examples that are closest to the inferencing input in an embedding space, for a predetermined value of k.

At step 226, step 210 may further include ensembling over a plurality of inferencing passes. Performing ensembling includes processing the inferencing input at the generative language model multiple times and aggregating the outputs of the generative language model. For example, majority-vote aggregation or ensemble refinement may be used to aggregate the outputs.

In some examples, at step 228, step 210 may further include selecting answer-choice-shuffled ensembling. Answer-choice-shuffled ensembling is performed by randomly rearranging a set of multiple-choice responses included in the prompt such that the prompts used in the plurality of inferencing passes have a plurality of different response orders. This shuffling corrects for a positional bias in the output selection process performed at the generative language model.

FIG. 5C shows additional steps of the method 200 that may be performed to train the reasoning model. At step 230, the method 200 may further include training the reasoning model on chain-of-thought (CoT) traces using reinforcement learning and/or supervised fine-tuning. The reasoning model may be trained starting from a pretrained base model.

FIG. 5C further shows steps 232, 234, 236, and 240, which may be included in step 230 in examples in which reinforcement learning is used to train the reasoning model. At step 232, for each of the CoT traces, step 230 includes computing the CoT trace at the generative language model. The CoT traces may be computed by processing respective training text inputs at the reasoning model. The CoT trace includes one or more intermediate-stage responses and a final-stage response.

At step 234, for each of the CoT traces, step 230 may further include computing one or more respective intermediate-stage loss values based at least in part on the one or more intermediate-stage responses using an intermediate-stage loss function. In some examples, an ML model may be used as a process reward model to compute the one or more intermediate-stage loss values. At step 236, for each of the CoT traces, step 230 may further include computing one or more respective final-stage loss values using a final-stage loss function based at least in part on the final-stage response. In some examples, an ML model may be used as an outcome reward model to compute the one or more intermediate-stage loss values.

At step 238, for each of the CoT traces, step 230 may further include training the generative language model based at least in part on the one or more intermediate-stage loss values and the final-stage loss value. Thus, the reasoning model is trained to generate accurate reasoning and final-stage responses.

Using the systems and methods discussed above, a set of one or more inferencing techniques is selected according to the specific generative language model and inferencing performance target that are used when processing an inferencing input. The one or more inferencing techniques are selected using an inferencing technique mapping included in an ML system along with a set of generative language models. This inferencing technique mapping accounts for differences in the effects of specific prompting and scaffolding techniques on reasoning models, relative to other types of generative language models. Thus, the systems and methods discussed above may allow the ML system to more easily reach a Pareto frontier of model output quality and computational resource usage.

The methods and processes described herein are tied to a computing system of one or more computing devices. In particular, such methods and processes can be implemented as a computer-application program or service, an application-programming interface (API), a library, and/or other computer-program product.

FIG. 7 schematically shows a non-limiting embodiment of a computing system 300 that can enact one or more of the methods and processes described above. Computing system 300 is shown in simplified form. Computing system 300 may instantiate the computing system 10 discussed above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive an inferencing input. The one or more processing devices are further configured to receive an inferencing performance target associated with the inferencing input. The inferencing performance target is selected from among a plurality of predetermined inferencing performance targets. The one or more processing devices are further configured to select a generative language model from among a plurality of generative language models based at least in part on the inferencing performance target. The one or more processing devices are further configured to select one or more inferencing techniques from among a plurality of inferencing techniques based at least in part on the inferencing performance target and generative language model metadata indicating whether the generative language model is a reasoning model. The one or more inferencing techniques are selected using an inferencing technique mapping that specifies a respective subset of the plurality of inferencing techniques for each of the generative language models and for each of the predetermined inferencing performance targets. The one or more processing devices are further configured to compute an inferencing output at the generative language model using the one or more selected inferencing techniques. The one or more processing devices are further configured to output the inferencing output. The above features may have the technical effect of selecting a set of one or more inferencing techniques that reflect the inferencing performance target and the properties of the generative language model with which the one or more processing devices process an inferencing input.

According to this aspect, the reasoning model may be trained on chain-of-thought (CoT) traces using reinforcement learning and/or supervised fine-tuning. The above features may have the technical effect of training the reasoning model to generate inferencing outputs that have CoT response patterns.

According to this aspect, the reasoning model may be trained using reinforcement learning. Performing the reinforcement learning on the CoT traces may include, for each of the CoT traces, computing the CoT trace at the generative language model. The CoT trace includes one or more intermediate-stage responses and a final-stage response. Based at least in part on the one or more intermediate-stage responses, performing the reinforcement learning may further include computing one or more respective intermediate-stage loss values using an intermediate-stage loss function. Based at least in part on the final-stage response, performing the reinforcement learning may further include computing one or more respective final-stage loss values using a final-stage loss function. Performing the reinforcement learning may further include training the generative language model based at least in part on the one or more intermediate-stage loss values and the final-stage loss value. The above features may have the technical effect of training the reasoning model to generate accurate intermediate-stage and final-stage responses in its CoT outputs.

According to this aspect, the plurality of inferencing techniques may include zero-shot prompting. The above feature may have the technical effect of computing the inferencing output without including few-shot examples in the prompt.

According to this aspect, the one or more processing devices may be configured to select zero-shot prompting using the inferencing technique mapping in response to determining that the generative language model metadata indicates that the generative language model is the reasoning model. The above features may have the technical effect of omitting few-shot examples from the prompt when the inclusion of few-shot examples is expected to decrease the accuracy of the inferencing output.

According to this aspect, the plurality of inferencing techniques may include random few-shot prompting. The above feature may have the technical effect of including one or more few-shot examples in the prompt to guide output generation.

According to this aspect, the plurality of inferencing techniques may include chain-of-thought (CoT) generation. The above feature may have the technical effect of prompting the generative language model to compute the inferencing output with a CoT structure.

According to this aspect, the plurality of inferencing techniques may include k-nearest-neighbors (kNN) few-shot prompting. The above feature may have the technical effect of using kNN matching to select few-shot examples that are similar to a requested generation task.

According to this aspect, the plurality of inferencing techniques may include ensembling over a plurality of inferencing passes. The above feature may have the technical effect of increasing output accuracy by generating and aggregating multiple outputs of the generative language model.

According to this aspect, the ensembling may be answer-choice-shuffled ensembling. The above feature may have the technical effect of mitigating a bias toward a specific position in a multiple-choice question.

According to this aspect, each of the predetermined inferencing performance targets may be a computational intensiveness target, an output accuracy target, or an output confidence target. The above features may have the technical effect of allowing the user to select different types of performance targets for the computation of the inferencing output.

According to another aspect of the present disclosure, a method for use with a computing system is provided. The method includes receiving an inferencing input. The method further includes receiving an inferencing performance target associated with the inferencing input. The inferencing performance target may be selected from among a plurality of predetermined inferencing performance targets. The method further includes selecting a generative language model from among a plurality of generative language models based at least in part on the inferencing performance target. The method further includes selecting one or more inferencing techniques from among a plurality of inferencing techniques based at least in part on the inferencing performance target and generative language model metadata indicating whether the generative language model is a reasoning model. The one or more inferencing techniques are selected using an inferencing technique mapping that specifies a respective subset of the plurality of inferencing techniques for each of the generative language models and for each of the predetermined inferencing performance targets. The method further includes computing an inferencing output at the generative language model using the one or more selected inferencing techniques. The method further includes outputting the inferencing output. The above features may have the technical effect of selecting a set of one or more inferencing techniques that reflect the inferencing performance target and the properties of the generative language model with which the one or more processing devices process an inferencing input.

According to this aspect, the method may further include training the reasoning model on chain-of-thought (CoT) traces using reinforcement learning and/or supervised fine-tuning. The above features may have the technical effect of training the reasoning model to generate inferencing outputs that have CoT response patterns.

According to this aspect, the plurality of inferencing techniques may include zero-shot prompting. The above feature may have the technical effect of computing the inferencing output without including few-shot examples in the prompt.

According to this aspect, the method may further include selecting zero-shot prompting using the inferencing technique mapping in response to determining that the generative language model metadata indicates that the generative language model is the reasoning model. The above features may have the technical effect of omitting few-shot examples from the prompt when the inclusion of few-shot examples is expected to decrease the accuracy of the inferencing output.

According to this aspect, the plurality of inferencing techniques may include random few-shot prompting. The above feature may have the technical effect of including one or more few-shot examples in the prompt to guide output generation.

According to this aspect, the plurality of inferencing techniques may include chain-of-thought (CoT) generation. The above feature may have the technical effect of prompting the generative language model to compute the inferencing output with a CoT structure.

According to this aspect, the plurality of inferencing techniques may include k-nearest-neighbors (kNN) few-shot prompting. The above feature may have the technical effect of using kNN matching to select few-shot examples that are similar to a requested generation task.

According to this aspect, the plurality of inferencing techniques may include ensembling over a plurality of inferencing passes. The above feature may have the technical effect of increasing output accuracy by generating and aggregating multiple outputs of the generative language model.

According to another aspect of the present disclosure, a computing system is provided, including one or more processing devices configured to receive an inferencing input. The one or more processing devices are further configured to receive a selection of a generative language model from among a plurality of generative language models. The one or more processing devices are further configured to select one or more inferencing techniques from among a plurality of inferencing techniques based at least in part on generative language model metadata indicating whether the generative language model is a reasoning model. The plurality of inferencing techniques include zero-shot prompting, random few-shot prompting, chain-of-thought generation, and ensembling over a plurality of inferencing passes. The one or more inferencing techniques are selected using an inferencing technique mapping that specifies a respective subset of the plurality of inferencing techniques for each of the generative language models. The one or more processing devices are further configured to compute an inferencing output at the generative language model using the one or more selected inferencing techniques. The one or more processing devices are further configured to output the inferencing output. The above features may have the technical effect of selecting a set of one or more inferencing techniques that reflect the properties of the generative language model with which the one or more processing devices process an inferencing input.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive an inferencing input;
receive an inferencing performance target associated with the inferencing input, wherein the inferencing performance target is selected from among a plurality of predetermined inferencing performance targets;
select a generative language model from among a plurality of generative language models based at least in part on the inferencing performance target;
select one or more inferencing techniques from among a plurality of inferencing techniques based at least in part on:
the inferencing performance target; and
generative language model metadata indicating whether the generative language model is a reasoning model,
wherein the one or more inferencing techniques are selected using an inferencing technique mapping that specifies a respective subset of the plurality of inferencing techniques for each of the generative language models and for each of the predetermined inferencing performance targets;
compute an inferencing output at the generative language model using the one or more selected inferencing techniques; and
output the inferencing output.

2. The computing system of claim 1, wherein the reasoning model is trained on chain-of-thought (CoT) traces using reinforcement learning and/or supervised fine-tuning.

3. The computing system of claim 2, wherein:
the reasoning model is trained using reinforcement learning; and
performing the reinforcement learning on the CoT traces includes, for each of the CoT traces:
computing the CoT trace at the generative language model, wherein the CoT trace includes one or more intermediate-stage responses and a final-stage response; and
based at least in part on the one or more intermediate-stage responses, computing one or more respective intermediate-stage loss values using an intermediate-stage loss function;
based at least in part on the final-stage response, computing one or more respective final-stage loss values using a final-stage loss function; and
training the generative language model based at least in part on the one or more intermediate-stage loss values and the final-stage loss value.

4. The computing system of claim 1, wherein the plurality of inferencing techniques include zero-shot prompting.

5. The computing system of claim 4, wherein the one or more processing devices are configured to select zero-shot prompting using the inferencing technique mapping in response to determining that the generative language model metadata indicates that the generative language model is the reasoning model.

6. The computing system of claim 1, wherein the plurality of inferencing techniques include random few-shot prompting.

7. The computing system of claim 1, wherein the plurality of inferencing techniques include chain-of-thought (CoT) generation.

8. The computing system of claim 1, wherein the plurality of inferencing techniques include k-nearest-neighbors (kNN) few-shot prompting.

9. The computing system of claim 1, wherein the plurality of inferencing techniques include ensembling over a plurality of inferencing passes.

10. The computing system of claim 9, wherein the ensembling is answer-choice-shuffled ensembling.

11. The computing system of claim 1, wherein each of the predetermined inferencing performance targets is a computational intensiveness target, an output accuracy target, or an output confidence target.

12. A method for use with a computing system, the method comprising:
receiving an inferencing input;
receiving an inferencing performance target associated with the inferencing input, wherein the inferencing performance target is selected from among a plurality of predetermined inferencing performance targets;
selecting a generative language model from among a plurality of generative language models based at least in part on the inferencing performance target;
selecting one or more inferencing techniques from among a plurality of inferencing techniques based at least in part on:
the inferencing performance target; and
generative language model metadata indicating whether the generative language model is a reasoning model,
wherein the one or more inferencing techniques are selected using an inferencing technique mapping that specifies a respective subset of the plurality of inferencing techniques for each of the generative language models and for each of the predetermined inferencing performance targets;
computing an inferencing output at the generative language model using the one or more selected inferencing techniques; and
outputting the inferencing output.

13. The method of claim 12, further comprising training the reasoning model on chain-of-thought (CoT) traces using reinforcement learning and/or supervised fine-tuning.

14. The method of claim 12, wherein the plurality of inferencing techniques include zero-shot prompting.

15. The method of claim 14, further comprising selecting zero-shot prompting using the inferencing technique mapping in response to determining that the generative language model metadata indicates that the generative language model is the reasoning model.

16. The method of claim 12, wherein the plurality of inferencing techniques include random few-shot prompting.

17. The method of claim 12, wherein the plurality of inferencing techniques include chain-of-thought (CoT) generation.

18. The method of claim 12, wherein the plurality of inferencing techniques include k-nearest-neighbors (kNN) few-shot prompting.

19. The method of claim 12, wherein the plurality of inferencing techniques include ensembling over a plurality of inferencing passes.

20. A computing system comprising:
one or more processing devices configured to:
receive an inferencing input;
receive a selection of a generative language model from among a plurality of generative language models;
select one or more inferencing techniques from among a plurality of inferencing techniques based at least in part on generative language model metadata indicating whether the generative language model is a reasoning model, wherein:
the plurality of inferencing techniques include zero-shot prompting, random few-shot prompting, chain-of-thought generation, and ensembling over a plurality of inferencing passes; and
the one or more inferencing techniques are selected using an inferencing technique mapping that specifies a respective subset of the plurality of inferencing techniques for each of the generative language models;
compute an inferencing output at the generative language model using the one or more selected inferencing techniques; and
output the inferencing output.
